(19) United States
(12) Patent Application Publication
(10) Pub. No.: US 2008/0027908 A1
(43) Pub. Date: Jan. 31, 2008

(54) Method for requesting and processing metadata which is contained in a data stream and associated device

(76) Inventors: Norbert Durbeck, Heideck (DE); Lutz Schlesinger, Erlangen (DE)

Correspondence Address: HARNESS, DICKEY & PIERCE, P.L.C., P.O.BOX 8910, RESTON, VA, 20195, US

(21) Appl. No.: 11/878,086

(22) Filed: Jul. 20, 2007

(30) Foreign Application Priority Data
Jul. 24, 2006 (DE) 10 2006 034 185.6

(51) Int. Cl. G06F 17/30; G06F 12/16

(52) U.S. Cl. 707/2; 707/204; 707/E17.143; 707/E17.014

(57) ABSTRACT

A method for requesting metadata which is contained in a data stream and an associated device for executing the method are designed to allow a particularly efficient and time-saving request of the data and, particularly in the case of a frequently or repeatedly required subset of the metadata contained in the data stream, to reduce or even minimize the required access time. This problem is improved upon or even solved in accordance with at least one embodiment of the invention by extracting at least a part of the metadata from the incoming data stream and copying it into a metadata storage during a preparation phase, and by storing the data stream in a data stream storage. In at least one embodiment, in a request phase which succeeds the preparation phase, incoming queries from an assigned application or from a system service for specific metadata or cumulation data are answered as far as possible on the basis of the metadata which is stored in the metadata storage, or on the basis of cumulation data which is derived therefrom, and wherein otherwise the data stream which is stored in the data stream storage is used for answering the query.

### PRIORITY STATEMENT

The present application hereby claims priority under 35 U.S.C. §119 on German patent application number DE 10 2006 034 185.6 filed Jul. 24, 2006, the entire contents of which is hereby incorporated herein by reference.

### FIELD

Embodiments of the invention generally relate to a method for requesting metadata which is contained in a data stream, or cumulation data which is derived from the metadata. They further generally relate to a device for processing a data stream, in particular a DICOM data stream.

### BACKGROUND

DICOM (Digital Imaging and Communications in Medicine) is an open standard which was developed and is maintained by the American College of Radiology (ACR) and the National Electrical Manufacturers Association (NEMA) for the exchange of medical image data and which, in particular, provides and specifies communication protocols for network-wide communication between at least one imaging device and associated processing and storage entities, file formats for various storage media, and uniform data structures for the actual image data and meta-information assigned thereto, e.g. patient data, device parameters or recording parameters. Above all, DICOM is intended to ensure the interoperability between various medical applications; within this concept, the medical imaging devices communicate independently of the system platform in use, the operating system or the manufacturer.

For this reason, the DICOM standard does not include any hardware-specific implementation rules or specifications in respect of the underlying database or storage structure. In particular, the associated access algorithms or access techniques and the details of the processing routines are not defined or standardized in greater detail.

The payload information and meta-information contained in a DICOM hierarchy are usually bundled in a continuous data stream, transferred within the network, (temporarily) stored, and processed sequentially in an associated data processing entity. In this case, in a hospital or community medical practice, for example, there is usually a certain amount of metadata (e.g. patient data) which, in comparison with the other parts of the data stream (e.g. the actual image data), must be accessed relatively frequently and might also be modified comparatively frequently.

In particular, it is necessary repeatedly to access processing attributes or status attributes (so-called flags) assigned to the individual information units of the DICOM hierarchy which are present in the data stream, and to request the current value of said attributes. This might involve, for example, the standardized DICOM flags “completion” (0040,A491) or “verification” (0040,A493), wherein the hexadecimal-encoded identification sequences preceding the relevant value field are specified in parentheses and the flags in the data stream can be identified and/or located with reference to said identification sequences. In some cases, it is also necessary frequently to query and read out or (temporarily) modify processing attributes such as, for example, “archived” or “exported” or other data fields which have freely definable contents and are provided in the context of proprietary extensions to the DICOM standard. These queries are distinctly time-consuming due to the sequential access to the DICOM data stream, particularly if they occur repeatedly, since it is necessary to analyze anew the whole data stream or at least a large portion thereof (e.g. up to a defined interrupt criterion) in a parser in the case of each individual query.

In this case, frequently it is not individual metadata or attributes themselves that are of interest, but merely data which is formed or derived therefrom and is modified, combined or cumulated, said data being referred to below as cumulation data for short. In the DICOM context featuring a “patient-study-series-instance” information hierarchy, for example, frequently all that is of interest is whether all instances of a series are already archived. However, since such combined information is frequently not present in the DICOM data stream itself, nor can it easily be added thereto, all that remains according to the current prior art is, with regard to each query, to check the data stream again in a parser for the presence of the corresponding individual flags and to generate the desired cumulated information therefrom. These search and query operations require a huge amount of (computing) time, particularly in the case of a study including several thousands of images, and therefore protracted and undesirable delays for the user and the operator of the corresponding medical system can only be avoided - if at all - by using comparatively powerful and therefore expensive hardware components.

### SUMMARY

In at least one embodiment, the present invention therefore addresses the problem of specifying a method of the type cited in the introduction and/or an associated device for executing the method, the method and/or device of at least one embodiment allowing a particularly efficient and time-saving request of metadata contained in a data stream, in particular of a frequently required subset of this metadata.

With reference to the method, the problem may be improved upon or even solved in accordance with at least one embodiment of the invention by extracting at least a part of the metadata from the incoming data stream and copying it into a metadata storage during a preparation phase, and by storing the data stream in a data stream storage, wherein in a request phase which chronologically succeeds the preparation phase, incoming queries from an assigned application or from a system service for specific metadata or cumulation data are answered as far as possible on the basis of the metadata which is stored in the metadata storage, or on the basis of cumulation data which is derived therefrom, and wherein otherwise the data stream which is stored in the data stream storage is used for answering the request.

At least one embodiment of the invention has as its starting point the consideration that, in order to improve the performance of the method, analyzing the complete data stream with the aid of a parser for each individual request for metadata (more precisely: the current value of a metadata field) should be avoided. Instead, the data stream should be subjected to a pre-analysis once in a preparation phase, wherein according to at least one embodiment of the invention in one stage the most frequently queried metadata or the values of corresponding data fields are “collected”, extracted from the data stream and stored in a manner which allows the extracted metadata to be identified unambiguously and, according to its respective meaning, to be assigned to the original position in the data stream or the location in the underlying information hierarchy of the data stream.

The metadata storage therefore represents a “pool” of frequently queried metadata, which is available there and separated from the less frequently demanded metadata and/or the “payload data”, this being very extensive in terms of data volume in some cases, and which is therefore easily accessible without time-intensive searching in the request phase following completion of the preparation phase. Furthermore, in this way it is possible to alter or modify the extracted metadata e.g. in the metadata storage without having to alter the original complete data stream. Furthermore, cumulated or combined data can be formed as required from the extracted metadata in a particularly efficient manner. As long as the metadata that is required to answer the respective query is present in the metadata storage, or the desired cumulation data can be formed exclusively from the extracted metadata, recourse to the complete data stream which is stored in a data stream storage is not necessary. If required, however, the complete data stream is also available.

The extraction of the metadata preferably takes place in a data extraction unit, which can also be a software-based component of a general data processing system. In this case, the metadata that is to be extracted from the data stream can be configured e.g. in a metadata list which can advantageously be adapted to changing query customs or frequencies. Although it is conceivable that the extraction acts in the manner of a shift operation, in which the extracted metadata is deleted from the input data stream, it is nonetheless advantageous always to copy the relevant metadata into the metadata storage. In this case, the output data stream which leaves the data extraction unit and is supplied to the data stream storage is identical to the input data stream and, if required, still contains all of its originally available--information in unmodified form and sequence.

The application of the method proposed here is particularly advantageous in the case of a data stream which—like e.g. a DICOM data stream - represents information which is hierarchically arranged in a tree structure, wherein a record of individual meta-information is assigned in each case to information units which form at least some nodes and end-nodes. For example, the DICOM information hierarchy “patient-study-series-instance” cited in the introduction can be used as a basis, wherein the information unit “patient” is usually optional, i.e. is not mandatory. The information units which are present on the logical/conceptual level and the meta-information which is assigned or attached thereto are represented on the implementation level of the data stream by corresponding data units or metadata which are advantageously identifiable by way of the individual identification sequences or UIDs (Unique Identifiers) which precede actual data value fields. However, it is also possible for metadata which does not have a direct correspondence on the logical level of the tree diagram to be integrated into the data stream.

The metadata to be extracted may include, for example, status attributes or processing attributes or “flags” of the type mentioned in the introduction, e.g. “archive” flags or similar, whose value is queried particularly frequently according to at least one embodiment of the invention. The metadata which is extracted from the data stream is advantageously stored in the metadata storage in such a way that its assignment to the information units that are organized in the tree structure, in particular to the attached meta-information, is retained. In a realization which is kept particularly simple, the extracted data values together with their identification sequences are strung together in a new and comparatively short (meta) data stream and stored thus in the metadata storage such that, in the case of a corresponding query from an application or a system service, only the short metadata stream from the metadata storage and not the original complete data stream must be parsed. In a variant which is somewhat costlier to implement but is nonetheless particularly advantageous in respect of the request effectiveness, the extracted metadata is stored in a data structure having direct, non-sequential access (e.g. array, relational database, etc.), wherein this data structure advantageously emulates to a large extent the information hierarchy (e.g. tree structure with nodes and end-nodes) that underlies the data stream.

In an advantageous development of at least one embodiment, during the preparation phase, cumulation data is formed from the metadata which is copied into the metadata storage, and is stored in a cumulation data storage, wherein incoming queries from an assigned application or from a system service during the subsequent request phase for specific metadata or cumulation data are answered on the basis of the cumulation data which is stored in the cumulation data storage if available there, alternatively on the basis of the metadata which is stored in the metadata storage and, if not available there either, on the basis of the data stream which is stored in the data stream storage. In practice, the (raw) metadata storage and the cumulation data storage and possibly the data stream storage can be separate storage areas of the same physical storage.

The described approach is particularly suitable if such cumulation data rather than the original (raw) metadata is the actual subject matter of the interest of the query, but the cumulation data itself is not explicitly present in the data stream, e.g. in the case of the question whether the “archive” flag is set for all elements of a series or a study. Precisely if such queries occur more frequently and repeatedly, the. performance advantages of the advance calculation of the cumulation data, this being aimed to some extent at a “stockpiling”, clearly outweigh the disadvantages associated with the additional storage requirements for the temporary storage of the cumulation data. Moreover, the querying application is relieved or freed from the task of itself having to form the cumulation data from the raw metadata, such that the program code of the application can be kept particularly simple, in particular with respect to the request algorithm. In particular, request interfaces which are integrated in the relevant application do not have to take the structure and the format of the (raw) metadata into consideration in this case.

In a particularly simple variant, queries from an application or system service are initially directed or forwarded to the cumulation data storage. If the query can be answered on the basis of the data available there, the answer is output and passed or transferred to the application. The query is thus successfully answered and concluded. Otherwise, the query is directed to the metadata storage in a next stage. If the query is again unsuccessful, i.e. cannot be answered on the basis of the extracted metadata, the complete data stream is still available in the data stream storage in a final stage of query processing.

In an advantageous development, queries from an application or system service are however analyzed on the basis of a decision algorithm which accesses an assignment table, and forwarded to the cumulation- data storage, the metadata storage or the data stream storage depending on the availability of the data required for answering. For the purposes of at least one embodiment of the invention, this decision and forwarding algorithm is integrated into a metadata information service which is connected on the data flow side between the querying application and the relevant storage units (metadata storage, cumulation data storage and data stream storage). The assignment table advantageously contains all information required for forwarding queries as applicable, said information relating to the information hierarchy (e.g. the DICOM hierarchy) underlying the data stream and to the available metadata—depending on the hierarchy level—and its permissible values, to the extracted metadata which is available in the metadata storage and, if applicable, to the type and manner of its cumulation and the format and structure of its storage in the respective storage. In this way, for example, an unnecessary forwarding of the queries to the cumulation data storage can be prevented if the data that is required for answering the query is not even present there; the query can applicably be directed immediately to the metadata storage or possibly also to the data stream storage instead.

Furthermore, it is particularly advantageous if composite queries from an application or a system service are translated by the aforementioned metadata information service into individual queries which, depending on availability, are answered on the basis of the data in the cumulation data storage, in the metadata storage or in the data stream storage, wherein the individual answers that are received are composed by the metadata information service into an overall answer which is forwarded to the querying application or to the system service. This preferably takes place in a manner which is transparent to the application.

A cache mechanism is advantageously integrated in the system architecture for carrying out the method. For the purposes of at least one embodiment of the invention, the cache mechanism is part of the metadata information service. In this case, incoming queries from an application or a system service and answers that are received in response are temporarily stored in a query storage (cache), wherein new queries are initially forwarded to the query storage and, if possible, answered on the basis of the data which is temporarily stored there. This allows recurring and very similar queries to be answered particularly quickly without having to access the other storage entities, which usually have longer access times.

It is also possible here again to break complex composite queries into individual queries which can be forwarded either directly to the cache storage or to the other storages (metadata storage, cumulation data storage, data stream storage) according to the availability of the data. For the purposes of at least one embodiment of the invention, the periodic or needs-based refreshment of the cache contents, whereby query results that are now outdated are replaced by current results, is monitored and executed by a suitable refresh algorithm.

It should also be noted that the previously described concepts and principles for the metadata information service (transparent transformation and relevant forwarding of complex queries, cache mechanism, etc.) can obviously also be used—slightly adapted—if the (raw) metadata storage is ignored in a specific case and the metadata is prepared and processed to form cumulation data immediately upon extraction from the data stream. Alternatively, it is also possible for solely a (raw) metadata storage but no cumulation data storage to exist.

In a particularly advantageous configuration, cumulation data or cumulated attributes are formed from the metadata which is stored in the metadata storage and is organized according to a tree structure, particularly from such metadata as that which represents processing attributes or status attributes, by forming a combination value from a number of metadata elements belonging to the same hierarchy level of the tree structure, said combination value being assigned to a data field corresponding to the next higher hierarchy level.

Whether the “printed” attribute or the “archived” attribute is set in all “instances” of a “series”, for example, might be of interest to a querying application in the context of DICOM. Such a combinational characteristic or attribute, containing the desired information in condensed form, is however not provided on either the “instance” or “series” hierarchy level in the DICOM standard. This shortcoming is resolved according to the concept now proposed, in that corresponding cumulated or compound attributes are produced and taken into consideration when forming the cumulation data.

For the purposes of at least one embodiment of the invention, the combined attributes are assigned to the next higher hierarchy level as a single “general attribute” in this case. In the cited example, an attribute, e.g. “printed”, which is set on the “series” level would therefore signify that the corresponding attribute is set or should be considered to be set for all units of the “instance” level located immediately below the “series” level. By virtue of the cumulation data which is formed thus, the cumulation data storage holds the relevant information directly available for the querying application; it is not necessary to parse the whole data stream anew each time and compose the desired overall result from the individual results that are derived therefrom.

In addition to the rules outlined above by way of example for forming and interpreting cumulation data, in particular cumulated or aggregated attributes, it is also possible to establish further semantic conventions which are aimed at minimizing the number of required accesses to the various storage entities and the number of required processing steps when handling the respective query or when actively altering attributes. Generally speaking, in this case the value of data fields corresponding to nodes and end-nodes of a hierarchy level of the tree structure is advantageously determined implicitly according to semantics which depend on the ancestors, the descendants or the siblings.

In the case of a first variant which is also known as “implicit children”, an attribute or flag which is set for a node on a specific level of the tree hierarchy has the implicit significance that the corresponding attribute or flag should also be considered to be set for all descendants (children) of the node concerned. For the purposes of at least one embodiment of the invention, this applies not only to the immediate offspring, but also to the generations of grandchildren, great-grandchildren, etc. as far as the end-nodes of the tree. In a second variant which is also known as “implicit parents”, an attribute which is set for a node or an end-node of the tree applies equally to all ancestors (parents). For the purposes of at least one embodiment of the invention, this again applies to ancestors or predecessor nodes of each level as far as the root of the tree. Finally, there is also the variant which is known as “implicit siblings”, in which an attribute which is set for a node or an end-node applies equally to all siblings belonging to the same parent node. In an advanced variant, it is also possible for all nodes or end-nodes of the relevant hierarchy level (generation) to be covered by the implicit significance of the attribute which is set.

From a practical standpoint, an optimization according to the “implicit children” method is particularly preferred, since it allows a particularly clear view of the data structure under all conceivable circumstances and, avoiding any ambiguities, is particularly easy and intuitive to understand and ultimately to implement. In this case, an XML-based solution at the present time appears to be particularly suitable for a practical realization and implementation of the concept, in particular for modeling the tree hierarchy, wherein query languages such as XPath or XQuery can be used for requesting and altering the data. Alternatively, for example, a relational database system can be used in connection with the query language SQL.

The cited semantic conventions, and any proprietary data fields and the like which are not DICOM-compliant, are preferably used exclusively for the cumulation data which is held or filed in the cumulation data storage, while the (raw) metadata storage stores exclusively DICOM-compliant metadata or attributes having explicit significance, i.e. no implicit semantics. As a result, metadata having the full original information content (e.g. time stamp) is available in the (raw) metadata storage—provided it has been extracted from the data stream—in case of doubt or if required.

Temporary alterations of the metadata or cumulation data, these being initiated by an assigned application, a system service or the metadata information service, are preferably performed subject to the agreed semantics on the cumulation data which is stored in the cumulation data storage. Thus, the data stream and the metadata in the metadata storage which is extracted therefrom remain as far as possible untouched. For the purposes of the invention, the previously cited metadata information service is responsible for the execution of such alterations and requests.

With regard to at least one embodiment of the device, the problem cited in the introduction may be improved upon or even solved by way of a device for processing a data stream, in particular a DICOM data stream, said device featuring a data extraction unit for extracting metadata which is contained in the data stream, a metadata storage for storing the extracted metadata, and a data stream storage for storing the complete data stream, wherein an application which is linked to the device accesses specific metadata, or cumulation data which is derived from the metadata, via an interconnected metadata information service that is connected on the data side to the metadata storage and to the data stream storage.

In an advantageous development, at least one embodiment of the device additionally features a data cumulation unit, this being interconnected on the data side between the metadata storage and the metadata information service, for forming cumulation data which is derived from the extracted metadata, and a cumulation data storage for storing the cumulation data. For the purposes of at least one embodiment of the invention, when forming the cumulation data, the data cumulation unit takes into consideration previously agreed implicit semantics as per the description above.

The advantages achieved by at least one embodiment of the invention reside particularly in providing a concept which, with acceptable complexity of the system architecture, allows a particularly rapid and efficient request and/or alteration of metadata which is contained in a data stream, particularly in a DICOM data stream, and in particular of status attributes or processing attributes. This objective is achieved by extracting the frequently required metadata from the data stream in a preliminary step and storing it “collected” in an independent separate storage entity for a multiplicity of subsequent requests. By virtue of the reduction, resulting from the data extraction, in the volume of data which must subsequently be searched, the burden of each subsequent request decreases correspondingly.

The concept can be further optimized by way of a suitable representation of the extracted metadata in a data structure which is adapted to the requests. It is moreover possible to generate supplementary information, which is not present in the data stream itself but is useful and frequently required, from the standard metadata in a single pass during the preparation phase, and to make it available for subsequent retrieval without the need to modify the data stream for this purpose. As a result of the choice of suitable compression and presentation methods, e.g. by establishing implicit semantics, the request and alteration of such cumulation data can be further optimized, e.g. by reducing the number of attributes that must be processed per alteration operation. The request method appears completely transparent from the perspective of the querying application, and therefore the integration measures relating to this transpire to be particularly simple.

The described aggregation and processing techniques are not just applicable to metadata or flags extracted from the data stream, but also to additionally defined non-standardized processing information which is not stored in the data stream itself, e.g. flags of the type “printed”, “archived” or “marked”. By way of a concrete application example for a flag of the type “marked”, it is possible to imagine that, for example, in an application consisting of a plurality of application tasks, one of the tasks sets the corresponding flag on a set of DICOM streams which are read and analyzed by another application task that executes work stages using the marked images accordingly.

A further preferred application field for the concepts and techniques described here is in the domain of workflow processing and control (workflow management), e.g. in the creation of so-called Performed Procedure Steps (PPS), in particular in relation to the monitoring, processing and management of workflows that occur in a hospital with the aid of a hospital information system (KIS). A PPS typically contains the identification sequences (UIDs) of all DICOM instances that are handled in a processing step or workflow step and, after it is generated, said PPS is sent to the other information systems that are required for the handling of the complete workflow, it therefore being possible for these other information systems easily to see which steps have already been serviced. As a result of (temporarily) marking, at the level of the metadata storage or the cumulation data storage, instances, series or studies which are handled or changed in the context of the workflow, the generation of a PPS is supported without constantly having to request or modify the DICOM data stream itself for this purpose. Consequently, the new concept could also be referred to using a keyword such as “virtual PPS”.

### BRIEF DESCRIPTION OF THE DRAWINGS

An example embodiment of the invention is explained in greater detail with reference to the drawings, in which:

FIG. 1 shows a graphical representation of a DICOM information hierarchy,

FIG. 2 shows an alternative graphical illustration of the DICOM information hierarchy as per FIG. 1, wherein a selection of associated status attributes and processing attributes is also listed in addition,

FIG. 3 schematically shows an extract from a data stream containing a number of metadata elements,

FIG. 4 shows a graphical illustration, in the manner of a data flowchart, of the main functional components of a data processing device which is configured for the processing of a data stream, in particular for the efficient answering of queries relating to metadata which is contained in the data stream,

FIG. 5 shows a flow diagram for the data extraction and data aggregation operations which are performed by the data processing device as per FIG. 4,

FIG. 6 shows a flow diagram for the routines which are executed by a metadata information service of the data processing device as per FIG. 4 in the case of incoming external queries,

FIG. 7 shows two equivalent illustrations of a data tree, having explicit semantics for the individual attributes on the right, and having implicit semantics (“implicit children”) on the left,

FIG. 8 shows a graphical illustration of the readout method for reading out the value of individual attributes, said method being used in the case of a data tree having semantics of the type “implicit children”,

FIG. 9 shows an illustration as per FIG. 8, but for semantics of the type “implicit parents” in this case,

FIG. 10 shows an illustration as per FIG. 8 or FIG. 9, but for semantics of the type “implicit siblings” in this case,

FIG. 11 shows a graphical illustration of the updating and simplification procedure when setting an attribute in a data tree having semantics of the type “implicit children”,

FIG. 12 shows an alternative example for the setting of an attribute in the case of semantics of the type “implicit children”,

FIG. 13 shows an illustration of the case which is analogous to FIG. 11 but has “implicit parents”,

FIG. 14 shows an illustration of the case which is analogous to FIG. 11 but has “implicit siblings”,

FIG. 15 shows a graphical illustration of the updating and simplification procedure when deleting an attribute in a data tree having semantics of the type “implicit children”,

FIG. 16 shows a further example for the updating of a data tree after the deletion of an attribute in the case of semantics of the type “implicit children”,

FIG. 17 shows an illustration which is similar to that in FIG. 15 but for the case of “implicit parents” here,

FIG. 18 shows an illustration which is similar to that in FIG. 15 but for the case of “implicit siblings” here, and

FIG. 19 shows an example for the reorganization operations which are required when inserting a new data unit in a data tree, here in the case of “implicit children”.

### DETAILED DESCRIPTION OF THE EXAMPLE EMBODIMENTS

The terminology used herein is for the purpose of describing particular embodiments only and is not intended to be limiting of the present invention-. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or- components-, but do not preclude the presence or addition of one or more other features, integers, steps, operations, elements, components, and/or groups thereof.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the terms “and/or” and “at least one of” include any and all combinations of one or more of the associated listed items.

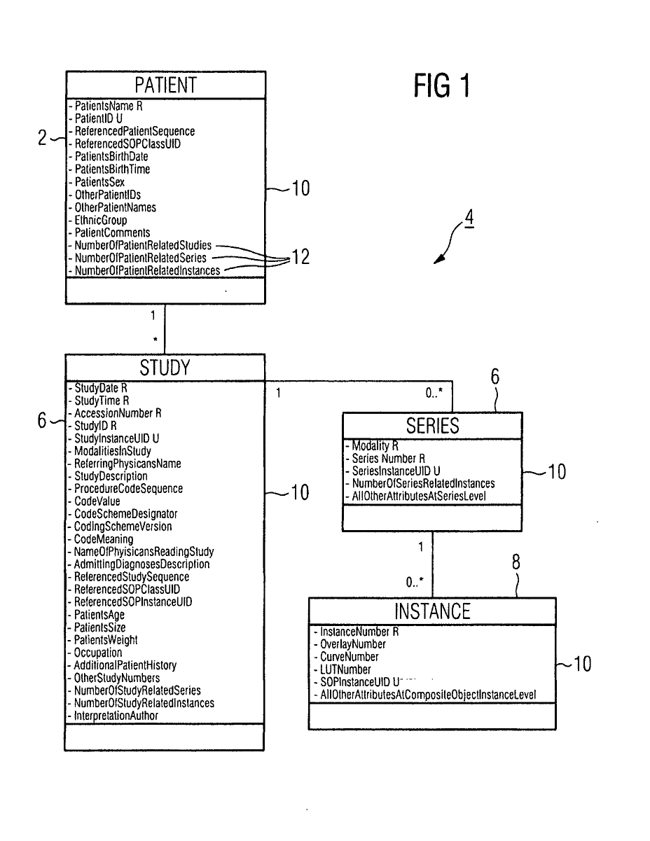

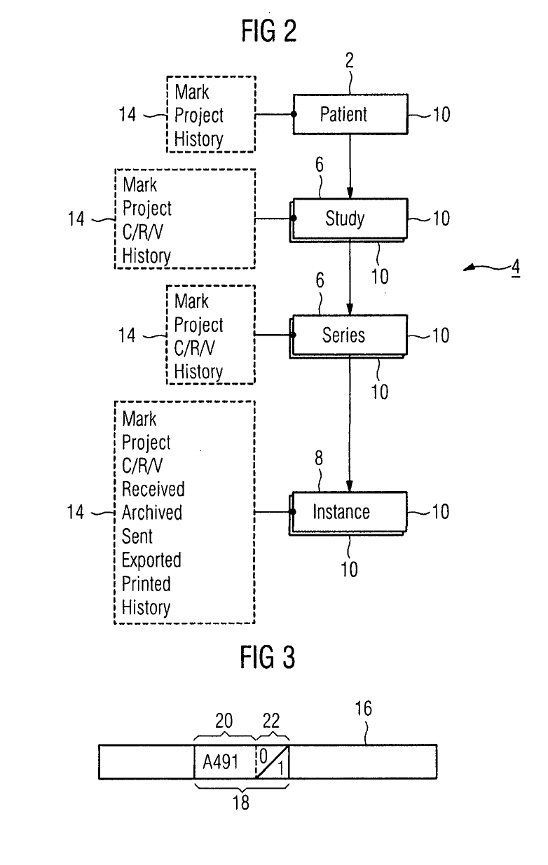

In schematic and simplified form, FIG. 1 shows a graphical representation of a DICOM information hierarchy as an example of a set of information which is organized into a tree structure and relates to medical imaging in this case. The so-called root 2 of the tree 4 is formed by the information unit 10 which is designated as “patient”, followed in the subordinate hierarchy levels by the units “study” and “series” as so-called nodes 6 of the tree 4, and at the lowest hierarchy level by the units which are designated as “instance” and form the so-called end-nodes 8 of the tree 4 in the present case. In the schematic illustration according to FIG. 1, only one of a plurality of “study” and “series” nodes and “instance” end-nodes is shown in each case. In accordance with UML class notation, the 1:n relationships are marked as 0/1 . . . * on the connection lines. The tree hierarchy is expressed more effectively in FIG. 2, which contains an alternative graphical illustration of the DICOM hierarchy. In this case, a multiplicity of information units 10 or data records is indicated in each case by two boxes highlighted in gray, of which the uppermost in each case partially covers those behind it (purely graphically, and not in terms of. content).

It is also evident from FIG. 1 that each of the information units 10 or data records assigned to a hierarchy level contains a number of application-specific attributes 12, these being mandatory or obligatory in some cases and optional or discretionary in other cases, which are listed here with their DICOM standard-compliant name designation. Furthermore, there is also a range of standardized status attributes or processing attributes 14, whose respective value is used for controlling and monitoring the process execution when the DICOM data is processed. A number of these are listed in FIG. 2 by way of example. In this case, it is evident that the DICOM standard provides different sets of status attributes 14 according to hierarchy level; the attribute “archived” can only be set on the “instance” level, for example, while the attribute “mark” is available on all levels.

A data stream 16 illustrated in FIG. 3 forms the basis of the processing in an electronic data processing system of the payload data and metadata in the DICOM hierarchy, wherein said data stream contains a continuous sequence of data records 18 or data packets corresponding to the individual information units 10 from FIG. 1 or FIG. 2 and can usually only be accessed sequentially. The identification and assignment of the individual data records 18 to the information units 10 according to their location or position in the above-described tree diagram takes place in this case using universal identification sequences 20 or UIDs (Unique Identifiers) which are located at the start of the data packets in the form of a so-called header. In this case, these are usually strings of numbers and letters of fixed length in hexadecimal format, which unambiguously characterize the relevant information unit 10 (patient, study, series, instance). Similarly, the subunits contained in the data packets, in particular the individual status attributes and processing attributes 14, can be identified by way of the individual header which is assigned to them within the data stream 16.

The ID of an attribute is generally composed of a so-called group number and an attribute number, both of which are usually four-character hexadecimal numbers. For example, the standardized DICOM attribute “completion” has the ID (0040,A491). Directly appended to the identification sequence 20 or ID in the data stream 16 is a data field 22 which represents the value of the attribute, e.g. “1” for “set” or “0” for “not set”. The sequence of the attributes in the data stream 16 is not permanently preset; the attributes contained in the data stream 16 are usually organized according to group number or attribute number, but not according to information unit 10 (patient, study, series, instance). In order to read out the value of a specific attribute from the data stream 16, it is therefore normally necessary to supply the whole DICOM data stream 16 to a parser which sequentially reads out the individual bits of the data stream 16 until the desired ID and thus the sought attribute is reached. The operation starts from the beginning again for the next query, this being a decidedly time-consuming and inefficient approach, particularly in the case of recurring queries of the same type.

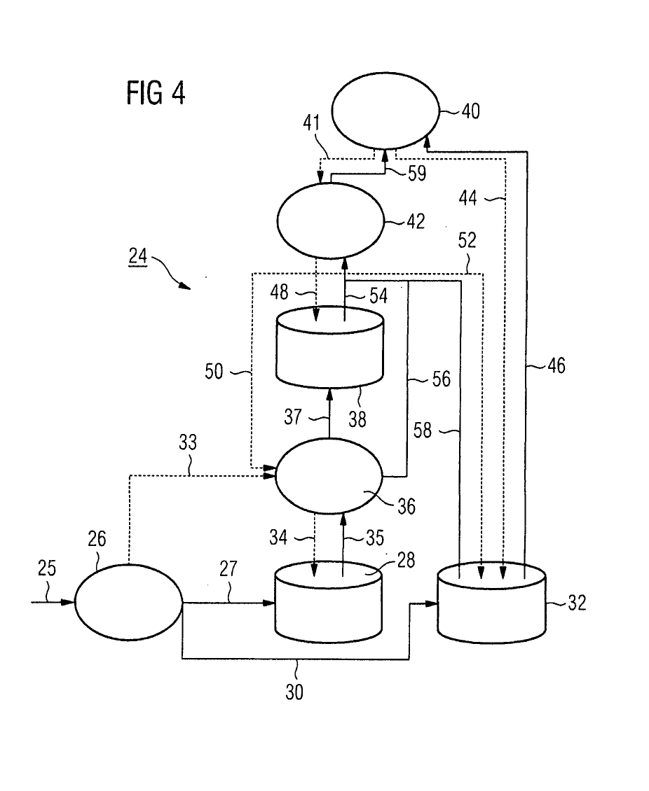

In order to improve the request efficiency, the processing device 24 which is schematically illustrated with its underlying logical functional components in the data flowchart in FIG. 4 features a data extraction unit 26 for the (input) data- stream 25,. wherein, on the basis of an attribute table, said data extraction unit 26 extracts a number of attributes (or more generally: metadata), which from experience are queried particularly frequently by an external application, from the incoming data stream 25 in a single pass and copies them via the data channel 27 to the metadata storage 28 (attribute storage). The output data stream 30 which leaves the data extraction entity 26 is identical to the input data stream 25 and is subsequently stored in a data stream storage 32. The direction of the data flow is illustrated in FIG. 4 by way of continuous lines having direction arrows in each case, while the flow of control instructions and queries is illustrated by way of broken lines.

Using the communication path 33, the data extraction unit 26 informs a data cumulation unit 36, which is connected to the metadata storage 28 on the data side, of newly arrived metadata in the metadata storage 28, whereupon the data cumulation unit 36 queries selected metadata from the metadata storage 28 via the query channel 34 and, according to its predefined rules, modifies and/or processes the metadata which is then received via the query channel 35 to form combined cumulation data. The cumulation data which is generated thus is then transferred via the data channel 37 to a further storage entity, the cumulation data storage 38, and stored there for answering future queries.

In the flow diagram illustrated in FIG. 5, the routines described above are summarized again in functional terms with regard to the collection and cumulation (aggregation) of the metadata: the program branch 80 symbolizes the extraction, which takes place in the data extraction unit 26, of relevant metadata from the incoming data stream 25. The complete data stream in the unchanged state is stored in the data stream storage 32 (program section 82), while the extracted metadata is copied into the metadata storage 28 (program section 84). Modified or cumulated metadata is then formed from selected metadata in the data cumulation unit 36 (program section 86) and filed in the cumulation data storage 38 (program section 88).

External user software or application 40 is linked, on one hand, via the interconnected metadata information service 42 to the above-described storage architecture comprising metadata storage 28, cumulation data storage 38 and data stream storage 32 on the data side; on the other hand, if necessary it has direct access via the query channel 44 and the DICOM data channel 46 to the complete data stream which is stored in the data stream storage 32. The direct communication path between the application 40 and the data stream storage 32 is normally only used for the transfer of large volumes of data, e.g. 2D or 3D image data; queries relating to metadata contained in the data stream, in particular to the value of status attributes or processing attributes or to cumulation data derived therefrom, are however sent from the application 40 via the query channel 41 to the metadata information service 42. The query arriving there is analyzed by the metadata information service 42 and, depending on the availability of the data required to answer it, is preferably forwarded via the query channel 48 to the cumulation data storage 38, alternatively via the query channel 50 to the metadata storage 28, and otherwise via the query channel 52 to the data stream storage 32. Complex composite queries are divided into individual queries if necessary and distributed to the corresponding storage entities.

The received answer to the query, i.e. the desired (raw or aggregated) metadata is then transferred via the data channel 54, the data channel 56 or the data channel 58 to the metadata information service 42. If a (complex) query was previously divided across the various storage entities, the individual answers are reassembled or composed again by the metadata information service 42. Finally, the (complete) answer is transferred from the metadata information service 42 via the data channel 59 to the querying application 40.

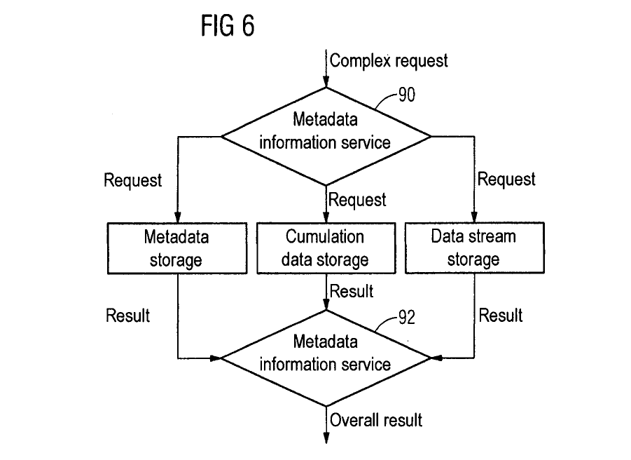

In the flow diagram illustrated in FIG. 6, the routines described above are- diagrammatically depicted and summarized again in functional terms with regard to the processing of queries: the program branch 90 symbolizes the splitting of a complex request and the distribution of the resulting individual requests to the various storage entities, here comprising metadata storage 28, cumulation data storage 38 and data stream storage 32, this being effected by way of the metadata information service 42. The received answers are subsequently composed to produce a complete answer (node point 92) and transferred in this form to the querying application 40, again by way of the metadata information service 42.

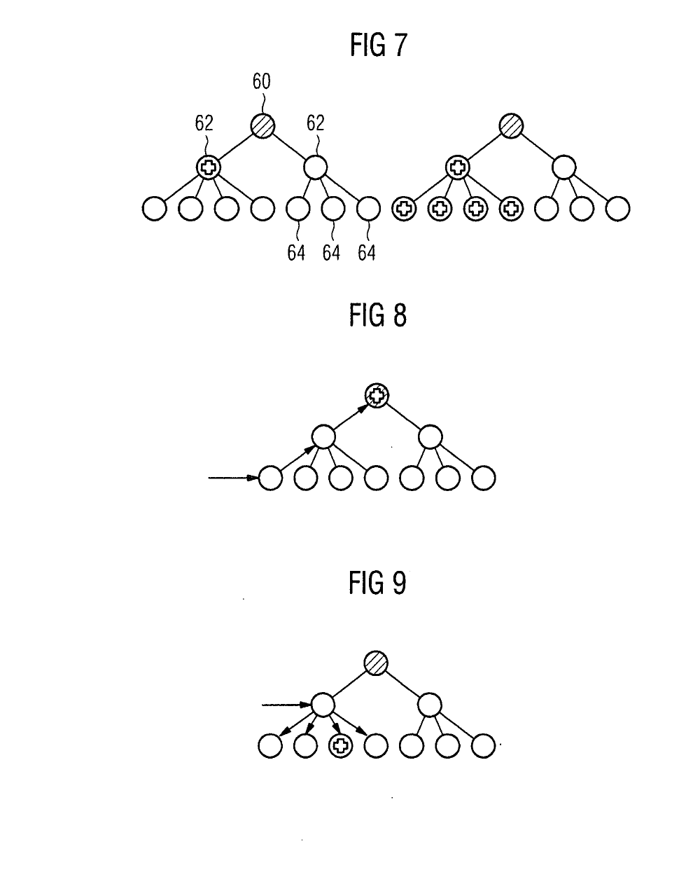

In FIG. 7, the principle of the data aggregation is illustrated schematically with reference to a tree structure which features a root node 60 on the upper hierarchy level, two nodes 62 on the central hierarchy level, these being reachable via directed paths from the root 60, and a total of seven end-nodes 64 on the lower hierarchy level, wherein the four end-nodes 64 positioned on the left are descendants (children) of the left-hand node 62 and the three end-nodes 64 positioned on the right are descendants (children) of the right-hand node 62 on the central hierarchy level. Each of the nodes 60, 62 and end-nodes 64 illustrated by a circle represents a status attribute or processing attribute (flag) which is contained in the DICOM hierarchy as per FIG. 1 or FIG. 2, is of the same type in each case, and can assume two different values in each case: flag set or not set.

In FIG. 7, the same data tree is illustrated twice side by side having an identical configuration of the individual attributes; the attribute values are based on explicit semantics in the right-hand half of the figure and on implicit semantics of the type “implicit children” in the left-hand half. In the case of the latter variant, an attribute which is set—illustrated here by way of a cross inside the circle—for a node 62 has the implicit significance that the successors which can be reached from this node (all subsequent generations) must likewise be considered as set. Applying this convention, the two configurations illustrated side by side in FIG. 7 are therefore equivalent.

The application of such implicit semantics reduces in many cases the number of attributes that must be handled and explicitly realized during the process execution, but sometimes results in an increase in the burden associated with reading out individual attributes since, according to the type of semantics (implicit children, implicit parents, implicit siblings), not only is it necessary to examine the relevant nodes or end-node of the data tree itself, but possibly all ancestors, descendants or siblings. This is illustrated e.g. for semantics of the type “implicit children” with reference to FIG. 8. In order to read out e.g. the attribute value of the end-node which is located at the lower far left and is designated by the horizontal arrow, it is necessary to trace the path which is designated by the arrows, against the direction of the attribute propagation (direction of inheritance) that is determined by the implicit semantics, back as far as the first set node, if necessary as far as the root node. In the case shown here, the attribute represented by the root node is set, and therefore all other attributes of the tree are likewise set as a result of the implicit semantics.

The same applies analogously in the case of semantics of the type “implicit parents”, in which the propagation direction for a set attribute from the end-node hierarchy to the root hierarchy indicates necessarily that all descendants of a node must be tested in order to determine its status. The tracing-back direction designated by the arrows in FIG. 9 is again opposite to the propagation direction (direction of inheritance of- the implicit semantics.

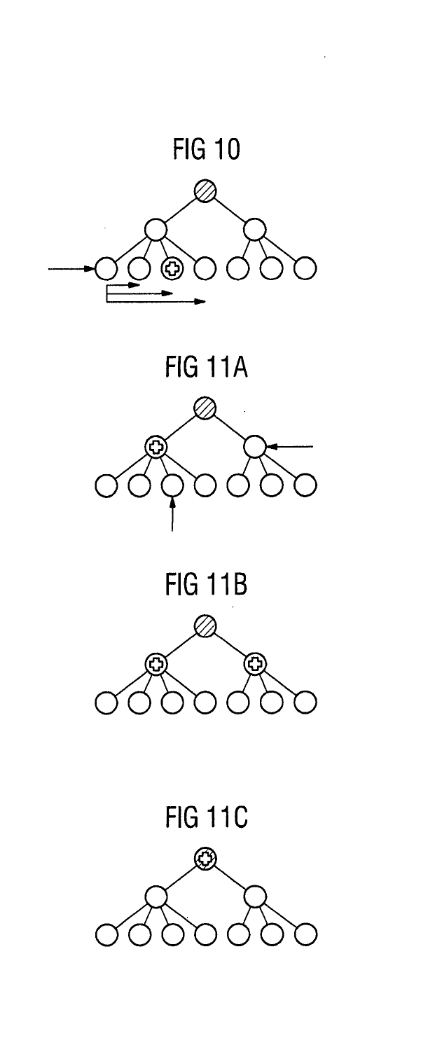

Finally, FIG. 10 illustrates the case of “implicit siblings”, in which all siblings of a node or end-node and belonging to the same parent node must be checked in order to determine its status.

If an attribute on a specific node or end-node of the tree must be set explicitly, this is initially straightforward and independent of the semantics in use. In the case of implicit semantics, however, it is usually necessary to update the data tree in order subsequently to remove redundant entries which are generated by such an operation.

This so-called aggregation of attributes is illustrated by way of example in FIG. 11 for the case of semantics of the type “implicit children”. FIG. 11A shows the initial state; the cross indicates an attribute which has already been set, and the two arrows indicate respectively a node and an end-node for which the attribute must be (explicitly) set. In the case of the end-node, however, it is not necessary to set the attribute explicitly at all, since it is already implicitly set as a result of the attribute which has been set for the parent node and the agreed implicit semantics. In order to eliminate such redundant entries, all explicitly set attributes which are already implicitly set by one of their predecessor nodes are therefore deleted again in a first step of the updating and optimizing phase. The result of this operation is illustrated in FIG. 11B. A further simplification can be achieved in a next step by combining a pair or groups of set attributes: if as in FIG. 11B, for example, all immediate offspring of a shared parent node have the status “attribute set”, the attribute can instead be set for the parent node in the form of a combination, and conversely deleted for the children since these are then implicitly covered by the parent node. The final result of this simplification or combination operation is illustrated in FIG. 11C for the exemplary case.

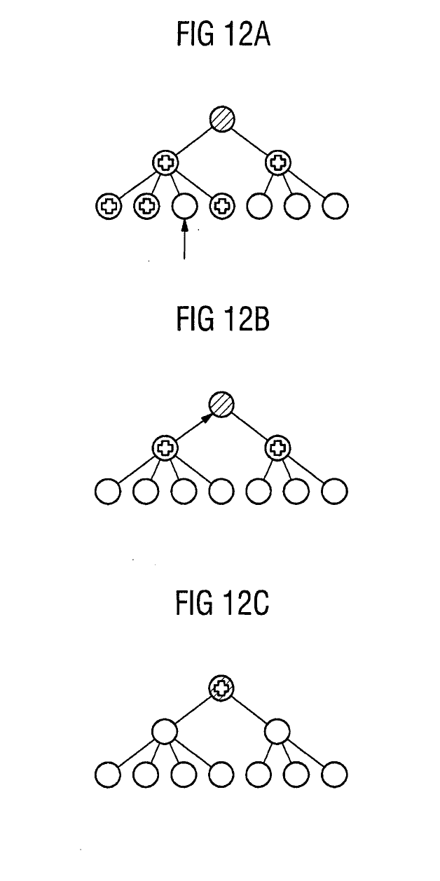

In general, the described combination procedure is iteratively repeated until the root node is reached. An example of this is illustrated in FIG. 12.

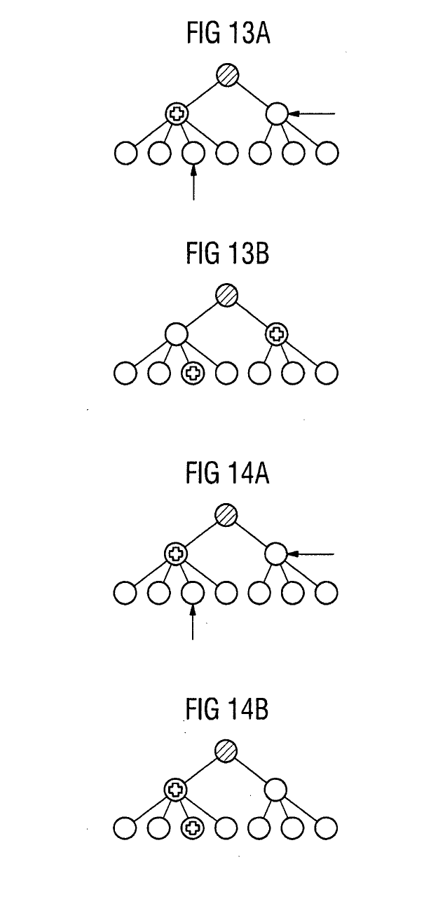

A similar approach is also possible in the case of semantics of the type “implicit parents”. An example of this is illustrated in FIG. 13. In the initial state which is illustrated in FIG. 13A, the two arrows again indicate nodes or end-nodes which must be set. Since all parent nodes are implicitly set by any one of their descendants, all ancestors of an explicitly set node or end-node can be deleted during a simplification procedure, thereby producing the final state shown in FIG. 13B. In this case, it cannot be avoided that some nodes, e.g. the root node in this example, are implicitly set by a plurality of their descendants.

Finally, FIG. 14 shows a similar simplification procedure for the case of “implicit siblings”.

While the aggregation of the attributes, in the case that a number of attributes must be set, is merely an appropriate but per se optional measure, by which redundant entries can be avoided or eliminated, in the converse case that an existing explicitly or implicitly set attribute must be deleted or removed, when using implicit semantics it is practically always necessary to perform an update in order to eliminate conflicting entries and avoid an erroneous interpretation of the result. Only in the case of explicit semantics does the deletion of an attribute act immediately and directly without any “side effects” on the ancestors, descendants or siblings.

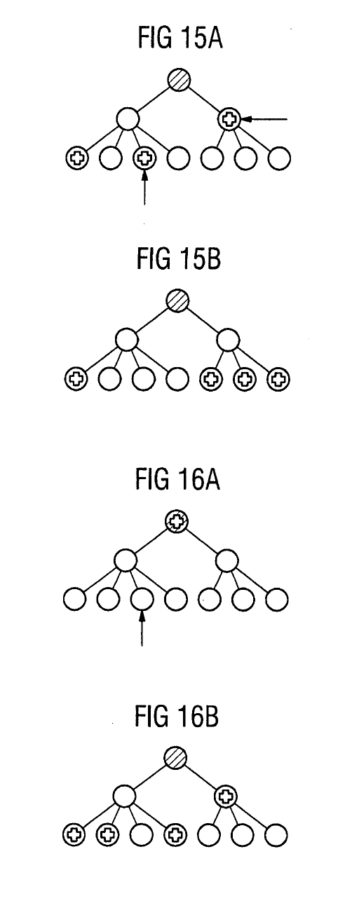

In order to illustrate this, for example, the two attributes indicated by way of arrows (and only these!) must be deleted in the initial state depicted in FIG. 15A and on the basis of semantics of the type “implicit children”. In this case, it must be taken into consideration that the right-hand node at the central hierarchy level, which node is set in the initial state, implicitly affects the end-nodes which are subordinate to it as children. If this effect of the corresponding parent attribute is not to be lost, the attributes of the children must be explicitly set “by hand” as it were. By contrast, the deletion of the attributes of end-nodes of the tree does not have any undesired effects which would have to be compensated by way of explicit “transformations”. The result of the procedure is illustrated in FIG. 15B.

In general, the procedure must be iteratively repeated starting from the root. An example for this is shown in FIG. 16, wherein however only the initial state (FIG. 16A) and the final state (FIG. 16B) are specified and the intermediary steps have been omitted. At the same time, FIG. 16 is an example of the case in which it is necessary to delete an attribute that was originally set implicitly.

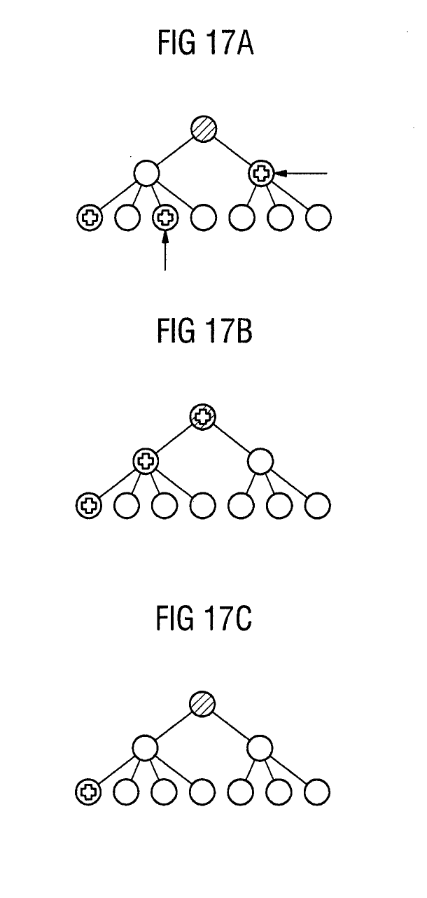

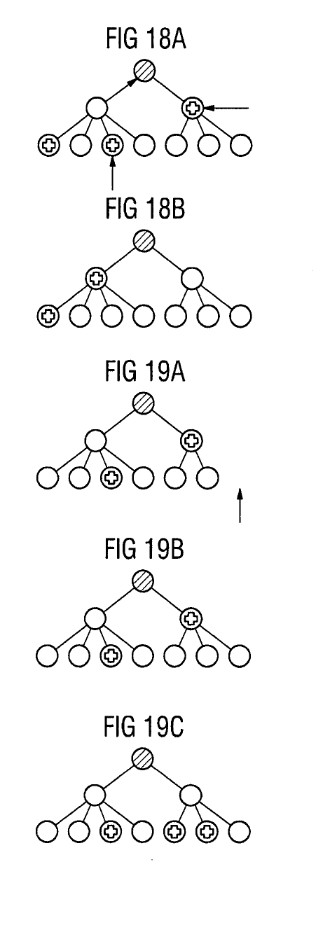

Similar examples are illustrated in FIG. 17 for the case of semantics of the type “implicit parents” and in FIG. 18 for the type “implicit siblings”. In the first-cited case, the originally implicitly set parent nodes of a node or end-node which must be deleted are explicitly set in a first step such that, starting from the initial state as per FIG. 17A, the intermediate state as per FIG. 17B is first produced. In a subsequent aggregation step, redundant attributes which are already implicitly set by their descendants are eliminated, such that the final state as shown in FIG. 17C occurs. In the case of semantics of the type “implicit siblings” (FIG. 18), it must be taken into consideration that a set attribute is also implicitly effective for all siblings belonging to a shared parent node. In order to prevent redundant entries, the remaining explicitly set sibling attributes can therefore be deleted.

If a new node or a new end-node is to be inserted into an existing tree, which corresponds in the DICOM context to e.g. the creation or insertion of a new data record of the type “instance”, “series” or “study”, it can be agreed in the case of implicit semantics that the attribute value of the newly inserted unit complies with the semantics, i.e. is inherited from the descendants, the ancestors or the siblings, for example. However, it can also be agreed that the new node or end-node is to be inserted with an explicitly predetermined attribute value. In this case, a reorganization of the remaining attributes in accordance with the previously explained propagation and aggregation techniques is generally required. For example, FIG. 19 shows the case in which a new end-node having an attribute that is not set must be inserted at the position marked by an arrow in the initial tree of FIG. 19A on the basis of semantics of the type “implicit children”. The reorganization steps required for this can be seen in the FIGS. 19B and 19C.

Finally, it might also be necessary to remove an end-node or a node from the tree completely. In the case of a node, thus its descendants must also be removed. This might also require corresponding reorganization steps in relation to the attributes of the remaining units. A detailed discussion is not required at this point.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for requesting at least one of metadata contained in a data stream and cumulation data derived from the metadata, the method comprising:
extracting at least a part of the metadata from the data stream; and
copying the extracted metadata into a metadata storage during a preparation phase;
storing the data stream in a data stream storage; and
answering, in a request phase which succeeds the preparation phase, incoming queries as far as possible, at least one of from an assigned application and from a system service for at least one of specific metadata and cumulation data, at least one of on the basis of the metadata stored in the metadata storage and on the basis of cumulation data derived therefrom.

2. The method as claimed in claim 1, wherein the extracted metadata is copied into the metadata storage, such that the data stream is left in its original state when the metadata is extracted.

3. The method as claimed in claim 2, wherein the data stream represents information organized in a tree hierarchy, and wherein a record of individual meta-information is assigned to information units which form at least some nodes and end-nodes.

4. The method as claimed in claim 3, wherein the metadata contained in the data stream corresponds to meta-information, and wherein at least one of an assignment and identification is performed on the basis of individual identification sequences integrated in the metadata.

5. The method as claimed in claim 3, wherein metadata extracted from the data stream is stored in the metadata storage such that its assignment to the information units, organized in the tree structure, is retained.

6. The method as claimed in claim 1, wherein the data stream is a DICOM data stream.

7. The method as claimed in claim 1, wherein the metadata comprises at least one of status attributes and processing attributes.

8. The method as claimed in claim 1, wherein, during the preparation phase, cumulation data is formed from the metadata which is copied into the metadata storage, and is stored in a cumulation data storage, and wherein incoming queries at least one of from an assigned application and from a system service during the subsequent request phase for at least one of specific metadata and cumulation data are answered at least one of on the basis of the cumulation data stored in the cumulation data storage if available there, alternatively on the basis of the metadata which is stored in the metadata storage and, if not available there either, alternatively on the basis of the data stream which is stored in the data stream storage.

9. The method as claimed in claim 8, wherein queries from at least one of an application and system service are analyzed on the basis of a decision algorithm which accesses an assignment table, and forwarded to the cumulation data storage, at least one of the metadata storage and the data stream storage depending on the availability of the data required for answering.

10. The method as claimed in claim 8, wherein composite queries from at least one of an application and a system service are translated by a metadata information service into individual queries which, depending on availability, are answered on the basis of the data in at least one of the cumulation data storage, the metadata storage and the data stream storage, and wherein the individual answers that are received are composed by the metadata information service into an overall answer which is forwarded to at least one of the querying application and the system service.

11. The method as claimed in claim 8, wherein cumulation data is formed from the metadata stored in the metadata storage and organized according to a tree structure, by forming a combination value from a number of metadata elements belonging to the same hierarchy level of the tree structure, said combination value being assigned to a data field corresponding to the next higher hierarchy level.

12. The method as claimed in claim 11, wherein a value of data fields corresponding to nodes and end-nodes of a hierarchy level of the tree structure is determined implicitly according to semantics which depend on at least one of the ancestors, the descendants and the siblings.

13. The method as claimed in claim 12, wherein temporary alterations of the metadata or cumulation data, these being initiated by at least one of an assigned application, a system service and a metadata information service, are performed subject to the agreed semantics on the cumulation data stored in the cumulation data-storage.

14. The method as claimed in claim 1, wherein incoming queries from at least one of an application and a system service and answers that are received in response are temporarily stored in a query storage, wherein new queries are initially forwarded to the query storage and, as far as possible, answered on the basis of the data which is temporarily stored there.

15. A device for processing a data stream, comprising:
a data extraction unit to extract metadata contained in the data stream;
a metadata storage to store the extracted metadata; and
a data stream storage to store the data stream, wherein an application, when linked to the device, is able to access at least one of specific metadata and cumulation data derived from the metadata, via an interconnected metadata information service connected on a data side to the metadata storage and to the data stream storage.

16. The device as claimed in claim 15, further comprising:
a data cumulation unit, interconnected on the data side between the metadata storage and the metadata information service, to form cumulation data derived from the extracted metadata; and
a cumulation data storage to store the cumulation data.

17. The method of claim 1, wherein the data stream stored in the data stream storage is otherwise used for answering the query.

18. The method as claimed in claim 4, wherein metadata extracted from the data stream is stored in the metadata storage such that its assignment to the information units, organized in the tree structure, is retained.

19. A computer readable medium including program segments for, when executed on a computer device, causing the computer device to implement the method of claim 1.

20. The device as claimed in claim 15, wherein the device is for processing a DICOM data stream.
